(19) United States
(12) Patent Application Publication
(10) Pub. No.: US 2007/0004615 A1
(43) Pub. Date: Jan. 4, 2007

(54) Cleaning composition

(76) Inventor: Brian Phillips, San Antonio, TX (US)

Correspondence Address: DAVID G. HENRY, 418 RIVERVIEW DRIVE, WOODWAY, TX, 76712, US

(21) Appl. No.: 11/172,448

(22) Filed: Jun. 30, 2005

(51) Int. Cl. C11D 17/08

(52) U.S. Cl. 510/421

(57) ABSTRACT

A cleaning composition useful in cleaning oil, exhaust residue and dirt-containing surface residue, particularly from aircraft lower surfaces. The composition includes, in its preferred form, D-limonene, a non-ionic surfactant, a fatty alkanolomide, and water.

### BACKGROUND OF THE INVENTION

1. Field of the Invention

The present invention pertains to cleaning preparations, and in particular to exterior vehicle preparations. More specific still, the present invention relates to compositions useful in removing surface contamination from aircraft surfaces, underside surfaces in particular, as are characterized by the mixture of oil, exhaust residue and “dirt.”

2. Background Information

Millions of dollars and incalculable people hours are spent cleaning aircraft. This is, in part, a product of the fact that aircraft perform better with clean, slick surfaces. Furthermore, however, the cost of most aircraft tend to prompt their owners (private owners, in particular) to keep their aircraft clean to a meticulous degree (analogous to the owner care prompted in the case of extremely expensive automobiles). Further still, certain aircraft essentially represent their corporate owners, and, in effect, constitute the owner's “flag” or “banner” for all to see. In short, aircraft owners and users usually prefer that aircraft be clean and attractive, and are willing to invest substantial sums and efforts to achieve that result.

Without any reasonable doubt, the biggest challenge to anyone charged with cleaning an aircraft relates to cleaning the under-surfaces, or “belly.” From personal experience, this writer can attest to the fact that cleaning surface contamination (a highly resilient and cleaning agent-resistant mixture of oil, exhaust residue and “dirt”) from an aircraft belly is the most challenging of all aircraft cleaning chores.

Numerous products are marketed for cleaning aircraft (and, of course, vehicles in general), and some are clearly more effective than others. Having tried every commercially available product known to the present inventor (himself an aircraft owner and cleaning composition manufacturer) nothing now available proves satisfactory. That is to say that, regardless of the cleaning composition or method used, substantial physical effort is required to acceptably removed surface contamination from the bellies of any of the aircraft tested by the present inventor.

Exhaustive mixing, re-mixing, trial and error to produce and effective cleaning composition for cleaning aircraft bellies, while still safe for painted surfaces produced a cleaning composition which eclipses all others known to the inventor, and to the present writer/patent attorney.

The composition of the present invention (method for the preparation of which is disclosed below) provides the first product known to the present inventor and this writer which permits spray-on-wipe-off effectiveness in cleaning “belly grime” from aircraft. This alone is significant, but clearly has implications for other difficult cleaning contexts, such as removing “road grime” from automobiles, and the like.

The availability of the cleaning composition of the present invention will eliminate countless hours of labor involved in cleaning aircraft. Whether an individual owner or company aircraft maintenance crew uses the present composition, substantial economies of time will be enjoyed. Any time persons are paid by the hour to clean aircraft, financial benefits will be realized by the aircraft owners and/or the aircraft cleaning personnel or business.

Finally, as reflected in a UPS television commercial of the past, the script of which read something like: “Not only does keeping our planes clean save thousands of gallons of fuel, we like our planes to look good.”, the ease of achieving cleaning results afforded by the present cleaning composition will likely prompt owners to clean more often which, in turn, will have the cumulative effect of reducing the consumption of enormous amounts of aircraft fuel. This has clear and significant economic and ecologically beneficial side effects.

### SUMMARY OF THE INVENTION

In view of the foregoing, it is an object of the present invention to provide a novel cleaning preparation.

It is another object of the present invention to provide a cleaning preparation which, to a more effective degree than presently available alternative products, affords easier cleaning of difficult-to-remove vehicle surface contamination.

It is another object of the present invention to provide a cleaning preparation which, to a more effective degree than presently available alternative products, affords easier cleaning of difficult-to-remove aircraft surface contamination.

It is another object of the present invention to provide a cleaning preparation which, to a more effective degree than presently available alternative products, affords easier cleaning of difficult-to-remove aircraft belly surface contamination.

In satisfaction of these and other related objectives, Applicant's present invention provides a novel and unobvious combination of chemical agents which, in combination, easily removes resilient surface contamination from surfaces, such as the lower surfaces of aircraft. The present composition, for the first time known to the present inventor, affords spray-on, wipe-off ease of cleaning surface contamination which, before, required substantial physical exertion, regardless of the product used. In addition, the present composition has proven safe for aircraft paint, as well as the underlying aluminum of which aircraft surface panels are made.

### DETAILED DESCRIPTION OF THE PREFERRED EMBODIMENT

The following steps are required for presently-believed, optimal manufacture a 48.5 gallon batch of the cleaning composition of the present invention:
1) To prepare “Mixture I”, Mix 12 gallons of D'limonene with 8 gallons of a non-ionic surfactant (E-Z-MULSE brand non-ionic surfactant from Florida Chemical Co. of New Haven, Fla. is recommended, based on current research by applicant—MSDS sheet attached as Appendix A to this specification);
2) To prepare “Mixture II”, Mix 1 gallon of non-ionic surfactant (same ingredient as so named above) with 2.5 gallons of a fatty alkanolomide (AMADOL 5130 brand from Akzo Nobel Surface Chemistry, LLC of Chicago Ill. is recommended, based on current research by applicant—MSDS sheet attached as Appendix B to this specification);
3) Fill a 55 gallon drum with 25 gallons soft water, add 3.5 gallons of Mixture II into the water and stir.
4) Slowly add 20 gallons of Mixture I and stir; and
5) Add 6.5 gallons of soft water to complete batch.

Clearly, industrial level scale-up of amounts shown above will be involved for commercial production of the present composition, but proportional changes in volumes to achieved desired batch volumes are well within the skills of persons operating a production facility as will be involved in such a manufacturing activity.

Once produced, use of the present composition is straight forward. Whether spraying from a aerosol pump-type container, or applying to a rag and wiping over a soiled surface, the composition is used as virtually any liquid cleaning composition, with specific amounts being substantially immaterial, so long as the surface is substantially wetted by the substance. The lower limit of application is that which, to the user, removes the surface contamination, while the upper limit is essentially that amount beyond which excess fluid simply rolls down the surface as waste. Therefore, use of the substance is substantially equivalent to use of a glass cleaner, furniture polish, spray-on car wax, or any such other liquid cleaning/polishing agent, including the recommended turning of the cleaning cloth or rag after such becomes visibly saturated with the cleaning composition and removed surface contamination.

Although the invention has been described with reference to specific embodiments, this description is not meant to be construed in a limited sense. Various modifications of the disclosed embodiments, as well as alternative embodiments of the inventions will become apparent to persons skilled in the art upon reference to the description of the invention. It is, therefore, contemplated that the appended claims will cover such modifications that fall within the scope of the invention.

I claim:

1. A cleaning composition comprising:
a first measure of D-limonene;
a second measure of a non-ionic surfactant;
a third measure of a fatty alkanolomide; and
a fourth measure of water.

2. The composition of claim 1 wherein the constituents are present in approximately the following ratios:
24 parts D-limonene to 18 parts non-ionic surfactant to 5 parts fatty alkanolomide to 50 parts water.

3. A method for producing a cleaning composition comprising the steps of:
first mixing a first volume of D-limonene with a second volume of non-ionic surfactant to form a first mixture;
second mixing a third volume of non-ionic surfactant with a fourth volume of fatty alkanolomide to form a second mixture;
third mixing a fifth volume of said Mixture II with a sixth volume of water; and
fourth mixing the combination of said Mixture II and said water with a seventh volume of said Mixture I.

4. A method for creating a cleaning preparation comprising the step of mixing a first measure of D-limonene; a second measure of a non-ionic surfactant; a third measure of a fatty alkanolomide; and a fourth measure of water.

5. The method of claim 5 wherein the stated constituents are present in the end product of such mixing in approximately the following ratios:
24 parts D-limonene to 18 parts non-ionic surfactant to 5 parts fatty alkanolomide to 50 parts water.
